(19) United States
(12) Patent Application Publication
(10) Pub. No.: US 2025/0238848 A1
(43) Pub. Date: Jul. 24, 2025

(54) SEARCH RESULTS OPTIMIZATION BY ADJUSTING A MULTI OBJECTIVE RANKING COMPUTER MODEL BASED ON SESSION INFORMATION

(71) Applicant: Maplebear Inc., San Francisco, CA (US)

(72) Inventors: Vinesh Reddy Gudla, South San Francisco, CA (US); Raochuan Fan, Sunnyvale, CA (US); Prakash Putta, Seattle, WA (US)

(21) Appl. No.: 18/421,890

(22) Filed: Jan. 24, 2024

(51) Int. Cl. G06Q 30/0601

(52) U.S. Cl. CPC G06Q 30/0631

(57) ABSTRACT

A trained computer model is used to adjust a revenue objective weight based on a current session of a user of an online system. In response to a user's search query, the online system retrieves a set of candidate items and applies a multi-objective ranking computer model to generate a set of weights for each candidate item, each weight associated with one specific objective of a set of objectives. The online system then applies a revenue adjustment computer model trained to adjust, based in part on content of a cart, a weight that is associated with a revenue objective. The online system generates a ranking score for each candidate item by applying the set of weights including the adjusted weight to the set of objectives. Based on the ranking scores, the online system selects one or more items from the set of the candidate items for recommendation to the user.

### BACKGROUND

Present-day online systems, such as online concierge systems, utilize machine-learning computer models to score content for their relevance to search queries and/or users of the online concierge systems. The traditional machine-learning models are typically trained as a multi-objective ranking model where one of multiple objectives is a revenue. The traditional multi-objective ranking model generates weights that are applied to the objectives including the revenue (i.e., price term) for computation of a ranking score for each item retrieved in response to a search query entered by a user of an online concierge system.

However, the weight applied to the revenue term is static at the user level and the search query level and does not take into account any information from a user's current ordering session. This limits the ability of a user interface to present useful content to a user of an online concierge system. Hence, there is a technical problem of improving the quality of content and recommendations that sometimes the traditional machine-learning models cannot provide. Therefore, there is a need for a new type of machine-learning model approach when providing content and recommendations to users of the online concierge system based on search queries entered by the users.

### SUMMARY

Embodiments of the present disclosure are directed to utilizing a trained computer model to adjust a revenue objective weight based on information about a current session of a user of an online system (e.g., online concierge system).

In accordance with one or more aspects of the disclosure, the online system receives a search query from a device associated with a user of the online system. The online system retrieves, from a database of the online system, a set of candidate items in response to the search query. The online system accesses a multi-objective ranking computer model of the online system trained to generate a plurality of weights for each candidate item in the set of candidate items, each of the plurality of weights associated with a respective objective of a plurality of objectives. The online system applies the multi-objective ranking computer model to generate, based at least in part on the search query and one or more features of the user, the plurality of weights for each candidate item in the set of candidate items. The online system accesses a revenue adjustment computer model of the online system trained to adjust a weight of the plurality of weights that is associated with a revenue objective of the plurality of objectives. The online system applies the revenue adjustment computer model to generate, based in part on content of a cart of the user for a current order, the adjusted weight for each candidate item in the set of candidate items. The online system generates a ranking score for each candidate item in the set of the candidate items by applying the plurality of weights comprising the adjusted weight to a plurality of objective scores, each of the plurality of objective scores associated with the respective objective of the plurality of objectives. The online system selects, based on the ranking score for each candidate item, one or more items from the set of the candidate items. The online system causes the device associated with the user to display a user interface with the one or more items for recommendation to the user for inclusion in a cart.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example user interface of a user client device with results of a search query entered by a user of an online concierge system, in accordance with one or more embodiments.

FIG. 4 is a flowchart for a method of using a trained computer model to adjust a weight of a revenue objective based on a session of a user of an online concierge system, in accordance with one or more embodiments.

### DETAILED DESCRIPTION

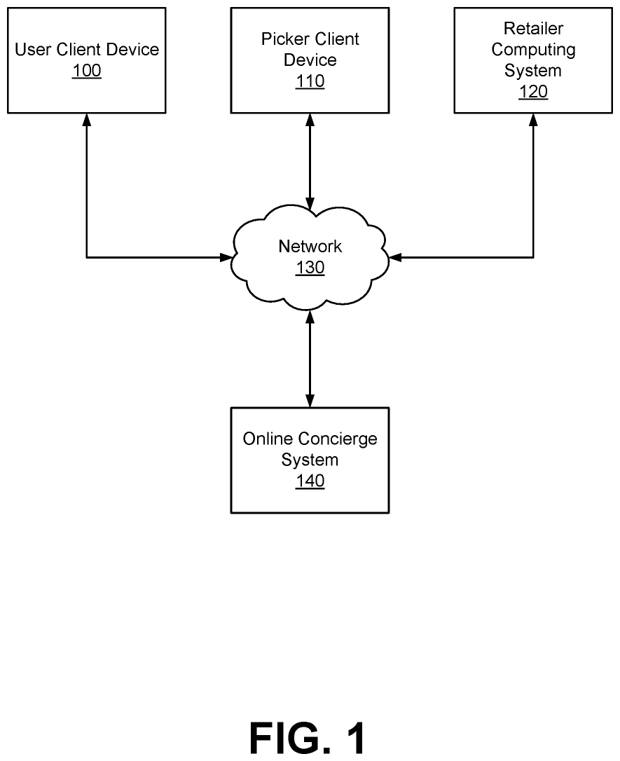

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 provides a search interface that receives a search query entered by a user of the online concierge system 140 (e.g., via the user client device 100). Responsive to the received search query, the online concierge system 140 retrieves a set of candidate items (or candidate search results) maintained in a database of the online concierge system 140 and scores each of the retrieved set of candidate items. The online concierge system 140 may score each candidate item using a multi-objective computer model (e.g., machine-learning model), where a score associated with each candidate item is a weighted sum of a set of objective scores that include a revenue objective score (or revenue). To improve the search results, the online concierge system 140 may adjust (e.g., decrease) the weight that is applied to the revenue objective score based on information about a current session of the user. In one or more embodiments, the adjustment of the weight applied to the revenue objective score may be based on how close a total monetary value of a user's current cart is to the user's typical spend (or budget). In one or more other embodiments, the weight applied to the revenue objective score is adjusted in accordance with a price sensitivity score of the user for a current session that is computed using information about items the user interacted with during the session.

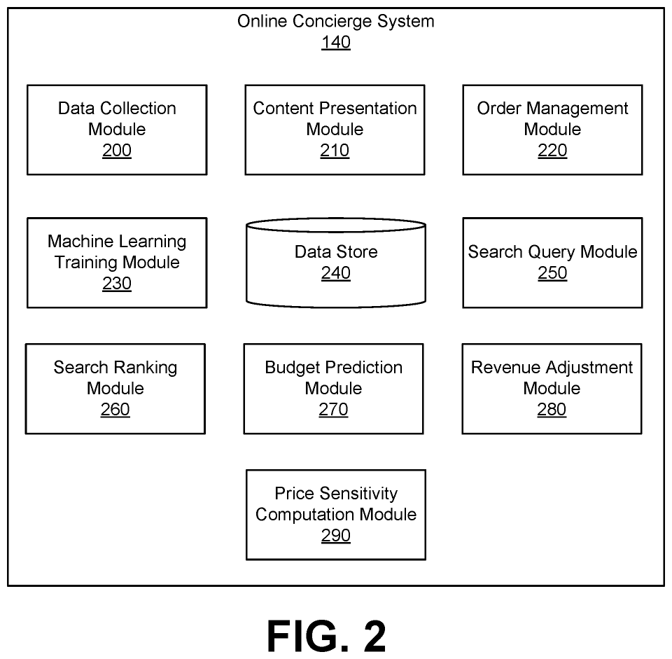

In one or more embodiments, the online concierge system 140 deploys a trained computer model (e.g., machine-learning computer model) to tune the weight of the revenue objective score based on information about the user's current session (e.g., content in the cart versus a typical user's budget). As the total monetary value (i.e., price) of content in the user's cart approaches the typical user's order budget, the online concierge system 140 may dynamically adjust the weight of the revenue objective score such that the weight of the revenue objective score is reduced. This may allow a user to further stretch their budget and induce them to checkout and/or adding more items to their current order. Inputs to the trained computer model may be: (1) user's session information (e.g., cart contents, item prices, item discounts etc.); (2) user's order budget; (3) user's session search/browse behavior (search/browse deals, engagement with higher/lower priced items etc.); (4) search results in response to an entered search query. Based on the inputs, the trained computer model may output an updated weight that will be then applied to the revenue objective score (or revenue) in the final item ranking. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a search query module 250, a search ranking module 260, a budget prediction module 270, a revenue adjustment module 280, and a price sensitivity computation module 290. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may re-train the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The search query module 250 may receive a search query entered by a user of the online concierge system 140 via a search interface of the user client device 100. In response to the received search query, the search query module 250 may retrieve (e.g., from the data store 240) a set of candidate items (i.e., candidate search results). Information about the set of specific candidate items retrieved by the search query module 250 may be provided to the search ranking module 260.

The search ranking module 260 may access a multi-objective computer model (e.g., machine-learning computer model) trained to compute a set of weights for each candidate item retrieved by the search query module 250, where each weight of the set of weights is associated with a respective objective of a set of objectives. The set of objectives may include a relevance objective, a revenue objective, an availability objective, a repeat purchasability objective (i.e., buy-it-again (BIA) objective), and one or more other objectives. The search ranking module 260 may deploy the multi-objective computer model to run a machine-learning algorithm to compute, based at least in part on the search query and one or more features of the user, the set of weights for each retrieved candidate item. A final score for each retrieved candidate item may be then obtained as a weighted sum of the set of objectives, where the set of weights are learned by the multi-objective computer model such that, e.g., a long-term revenue (or some other business metric) is optimized. A set of parameters for the multi-objective computer model may be stored at one or more non-transitory computer-readable media of the search ranking module 260. Alternatively, the set of parameters for the multi-objective computer model may be stored at one or more non-transitory computer-readable media of the data store 240.

In one or more embodiments, the final score for each retrieved candidate item is computed as the weighted sum of the set of objectives, i.e., the weighted sum of the relevance score, the revenue, the availability score, and the BIA score as:

item_score=w1*relevance_score+w2*revenue+w3*availability_score+w4*BIA_score, (1)

where the relevance score, the revenue, the availability score, and the BIA score may be determined by corresponding trained computer models of the online concierge system 140. Alternatively, one or more of the relevance score, the revenue, the availability score, and the BIA score may be imported to the online concierge system 140 from one or more outside sources.

The final score for each retrieved candidate item may be adjusted in accordance with a gross monetary value (GMV) based reranking function that re-ranks the candidate items based on a price of each candidate item in the set of candidate items, i.e.,

item_score=item_score*[1+0.25*price_elasticity*item_price], (2)

where item_score at the righthand side of equation (2) may be computed in accordance with equation (1), price_elasticity is a price elasticity score for the user that can be computed by a trained computer model of the online concierge system 140 or imported from an outside source, and item_price is a price (i.e., monetary value) of the retrieved item.

Alternatively, a score for each retrieved candidate item may be adjusted in accordance with a different GMV-based reranking function, i.e.,

item_score=item_score*[1+w1*embedding_score*min(C,item_price)*exp(−price_elasticity)], (3)

where item_score at the righthand side of equation (3) may be computed in accordance with equation (1) or may be a predetermined value, embedding_score is a score related to a relevance of the retrieved item, C is a predetermined constant monetary value (e.g., C=$60), item_price is a price (i.e., monetary value) of the retrieved item, and price_elasticity is a price elasticity score for the user that can be computed by a trained computer model of the online concierge system 140 or imported from an outside source. Note that, in such case, the multi-objective computer model may adjust the weight w1 in equation (3) based on information about the current session.

Then, the final score for each retrieved candidate item may be adjusted as:

item_score=w1*item_score+w2*revenue+w3*availabilty_score+w4*BIA_score, (4)

where item_score at the righthand side of equation (4) may be computed in accordance with equation (2), availability_score is an availability (i.e., dependability) score for the retrieved item that can be computed by a trained computer model of the online concierge system 140 or imported from an outside source, and BIA_score is a repeat purchasability (i.e., repeatability) score for the retrieved item that can be computed by a trained computer model of the online concierge system 140 or imported from an outside source. Note that, in such case, the multi-objective computer model may adjust the weight w2 in equation (4) based on information about the current session, as further discussed below.

The set of weights computed by the multi-objective computer model includes a weight that is associated with the revenue objective, i.e., the weight w2 in equation (1) and equation (4). The multi-objective computer model computes the weight associated with the revenue objective, w2, based on the user/search query pair. However, the multi-objective computer model does not take into account additional information about the current session, such as the user's typical budget or the user's price sensitivity. Thus, for users who are perceived to be more price insensitive, more premium items may be shown in their search results. However, as the users get closer to their regular order budget, this can result in the users not going ahead with their orders. Hence, the static weighting scheme that is not personalized to the user's session can decrease a user's probability of conversion. As a total monetary value of a user's cart approaches an overall user's budget for an order, the weight associated with the revenue objective, w2, would be adjusted. In one or more embodiments, the weight associated with the revenue objective, w2, is updated based on an estimated typical order budget for the user. In one or more other embodiments, the weight associated with the revenue objective, w2, is updated based on a price sensitivity score for the user during the current session.

The budget prediction module 270 may compute (or, more generally, estimate) a typical order budget for the user. In one or more embodiments, the budget prediction module 270 accesses a budget prediction computer model (e.g., machine-learning computer model) of the online concierge system 140 trained to predict a user's budget for a current order. The budget prediction module 270 may deploy the budget prediction computer model to run a machine-learning algorithm to estimate, based at least in part on an order history of the user for a defined time period (e.g., week, two weeks, month, etc.), the budget for the current order. The budget prediction computer model may be trained to compute an accurate order budget, which is particularly important for users with a less predictable order frequency. A set of parameters for the budget prediction computer model may be stored at one or more non-transitory computer-readable media of the budget prediction module 270. Alternatively, the set of parameters for the budget prediction computer model may be stored at one or more non-transitory computer-readable media of the data store 240.

In one or more other embodiments, the budget prediction module 270 empirically estimates a typical order budget for the user. Based an order history of the user (e.g., quantiles of budgets based on the user's past orders as available at the data store 240), the budget prediction module 270 may compute an average budget for the user for a defined time period (e.g., week, two weeks, month, etc.). Based on the computed average budget for the defined time period (e.g., predicted weekly budget), the budget prediction module 270 may estimate a budget for the current order.

The revenue adjustment module 280 may adjust a value of the weight associated with the revenue objective, i.e., a value of the weight w2 applied in equation (1) (and/or in equation (4)) for computation of the final score for each candidate item. The revenue adjustment module 280 may access a revenue adjustment computer model (e.g., machine-learning computer model) of the online concierge system 140 trained to adjust the value of the weight associated with the revenue objective. The revenue adjustment module 280 may deploy the revenue adjustment computer model to run a machine-learning algorithm to generate, based on information about the current session (e.g., information about the user's current shopping state), the adjusted value of the weight associated with the revenue objective, w2, for each candidate item in the set of candidate items. A set of parameters for the revenue adjustment computer model may be stored at one or more non-transitory computer-readable media of the revenue adjustment module 280. Alternatively, the set of parameters for the revenue adjustment computer model may be stored at one or more non-transitory computer-readable media of the data store 240.

The revenue adjustment module 280 may provide one or more inputs to the revenue adjustment computer model with the information about the current session. The one or more inputs to the revenue adjustment computer model may include at least one of: content of a current cart of the user, a budget for the current order (e.g., as estimated by the budget prediction module 270), information about a browsing activity of the user during the current order (e.g., including any suitable information about items the user viewed during the current session), or information about a defined number of previous searches associated with the user (e.g., including any information about discounts viewed by the user). Based on the one or more inputs with the information about the current session, the revenue adjustment computer model may generate the adjusted value of the weight associated with the revenue objective.

As the user, during the session, approaches their regular order budget, the revenue adjustment computer model may adjust the weight associated with the revenue objective downwards so that lower priced items and/or discounted items are listed higher up in the search results. Hence, the revenue adjustment computer model may decrease the weight associated with the revenue objective as the total monetary value of the cart gets closer to the order budget. In one or more embodiments, the revenue adjustment computer model may adjust (e.g., decrease) the weight associated with the revenue objective as more items are added to the cart. For example, in such cases, a cheaper item with a lower consumer rating may be prioritized over a more expensive, higher rated item as the total monetary value of the cart approaches the user's order budget.

In one or more embodiments, the revenue adjustment computer model may apply a weighted decay function to adjust (e.g., decrease) the value of the weight associated with the revenue objective, w2, i.e.,

w2=w2*[1−sum_cart_items/k*order_budget]\hat{ }alpha, (5)

where sum_cart_items is a total monetary value of content in the cart, order_budget is the estimated order budget, k is a predetermined tolerance parameter around the order_budget, and alpha is a predetermined decay coefficient. Note that the higher the value of parameter k, the greater is the allowed deviation from the order budget before decaying of the weight w2 starts to be effective.

In one or more embodiments, the revenue adjustment computer model may apply a linear function to adjust (e.g., decrease) the value of the weight associated with the revenue objective, w2, i.e.,

w2=w2−alpha*sum_cart_items/order_budget, (6)

where sum_cart_items is a total monetary value of content in the cart, order_budget is the estimated order budget, and alpha is a predetermined linear coefficient.

Upon the adjustment (e.g., decrease) of the weight associated with the revenue objective, w2, the revenue adjustment module 280 may compute a final ranking score for each candidate item in the set of the candidate items. The revenue adjustment module 280 may compute the final ranking score by applying the set of weights with the adjusted weight w2 to the set of objectives, i.e., to the relevance objective represented by the relevance score, the revenue objective, the availability objective represented by the availability score, and the repeat purchasability objective represented by the BIA score, in accordance with equation (1) (and/or equation (4)).

In one or more embodiments, when the weight w2 is adjusted by the revenue adjustment computer model in accordance with equation (5), the revenue adjustment module 280 computes the final ranking score for each candidate item as:

item_score=w1*relevance_score+w2*[1−sum_cart_items/k*order_budget]\hat{ }alpha*revenue+w3*availability_score+w4*BIA_score, (7)

where w2 in equation (7) is the initial value of the weight associated with the revenue objective as computed by the multi-objective ranking computer model.

In one or more other embodiments, when the weight w2 is adjusted by the revenue adjustment computer model in accordance with equation (6), the revenue adjustment module 280 computes the final ranking score for each candidate item as:

item_score=w1*relevance_score+[w2−alpha*sum_cart_items/order_budget]*revenue+w3*availability_score+w4*BIA_score, (8)

where w2 in equation (8) is the initial value of the weight associated with the revenue objective as computed by the multi-objective ranking computer model.

The price sensitivity computation module 290 may compute a price sensitivity score for a user's current session. The price sensitivity score may be computed using information about the user's current session, such as information about content of a user's cart, information about a browsing activity of the user during the current session (e.g., including any suitable information about items the user viewed during the current session), information about a defined number of previous searches associated with the user (e.g., including any information about discounts viewed by the user), some other suitable information about the user's current session, or some combination thereof.

In one or more embodiments, the price sensitivity computation module 290 computes the price sensitivity score for the current session using a set of defined rules. The price sensitivity computation module 290 may first collect information about a monetary value for each item in a set of items the user interacted with during the current session. This set of items may include a first subset of items that are added to the user's cart and a second subset of items that the user only viewed (e.g., clicked on them) during the current session. For each item in the set of items, the price sensitivity computation module 290 may compute a ratio of the monetary value (i.e., price) of that item to an average price for a category of that item. The price sensitivity computation module 290 may compute the price sensitivity score using the computed ratio for each item in the set of items the user interacted with during the current session. Each computed ratio may be also normalized such that the computed price sensitivity score has the value between 0 and 1. The price sensitivity score closer to 0 means that the user's current session is less price sensitive. And vice versa when the price sensitivity score is closer to 1. If the price sensitivity score is close to 1, then more discounted items should be shown to the user (or shown on top of a user interface of the user client device 100).

In one or more other embodiments, the price sensitivity computation module 290 accesses a price sensitivity computer model (e.g., machine-learning computer model) of the online concierge system 140 trained to generate the price sensitivity score for the user's current session. The price sensitivity computation module 290 may deploy the price sensitivity computer model to run a machine-learning algorithm to generate, based on a first embedding associated with the current session and a second embedding associated with each item in a set of items the user interacted with during the current session, the price sensitivity score for the current session of the user. A set of parameters for the price sensitivity computer model may be stored at one or more non-transitory computer-readable media of the price sensitivity computation module 290. Alternatively, the set of parameters for the price sensitivity computer model may be stored at one or more non-transitory computer-readable media of the data store 240.

The price sensitivity computer model may be a two-tower computer model. A first tower of the price sensitivity computer model may be trained to generate, based on a sequence of user's actions performed during the session (e.g., clicking on items displayed on discount pages, browsing discount pages, viewing of items, etc.), the first embedding associated with the current session. A second tower of the price sensitivity computer model may be trained to generate the second embedding based on one or more features of each item the user interacted with during the session. Based on the first and second embeddings, the price sensitivity computer model may compute the price sensitivity score as, e.g., a ratio of an average price of items the user interacted during the session and a median price (or historical price) of the items the user interacted during the session.

Upon computation of the price sensitivity score, the revenue adjustment module 280 may adjust the value of the weight associated with the revenue objective using the price sensitivity score. In one or more embodiments, the revenue adjustment module 280 adjusts the value of the weight associated with the revenue objective, w2, as given by:

w2=w2−alpha*price_sensitivity, (9)

where w2 on the righthand side of equation (9) is computed by the multi-objective ranking computer model, price_sensitivity is the price sensitivity score (e.g., between 0 and 1), and alpha is a predetermined price sensitivity parameter. It can be observed from equation (9) that, depending on prices of items already in the user's cart and/or the percentage of discounted items in their cart (which is represented by the price sensitivity score), the revenue objective can be downweighted.

In one or more other embodiments, the revenue adjustment module 280 applies the revenue adjustment computer model to generate, based at least in part on the content of the user's cart and the price sensitivity score, the adjusted value of the weight associated with the revenue objective for each candidate item in the set of candidate items that were retrieved in response to the search query entered by the user. Once the weight associated with the revenue objective, w2, is adjusted based on the price sensitivity score, the search ranking module 260 may compute the final ranking score for each candidate item in the set of retrieved candidate items as a weighted sum of the set of objectives, in accordance with equation (1) (and/or equation (4)) where the adjusted weight w2 is applied. Upon the computation of the final ranking score for each retrieved item, the search ranking module 260 may select a list of items (e.g., one or more items) from the set of the candidate items that have the highest final ranking scores. The search ranking module 260 may select the list of items such that each item in the list have a final ranking score greater than or equal to a threshold score. Alternatively or additionally, the search ranking module 260 may select the list of items such that no more than a predefined number of items is in the selected list of items.

The content presentation module 210 may obtain (e.g., from the search ranking module 260) the selected list of items for recommendation to the user. The content presentation module 210 may cause the user client device 100 to display (e.g., before the checkout) a user interface with the selected list of items. The user may be then allowed to add any of the recommended items to a shopping cart. In one or more embodiments, items from the selected list are displayed at the user interface of the user client device 100 such that an item with the largest discount is displayed on the top of the user interface (e.g., as determined by the content presentation module 210). Additionally, the content presentation module 210 may cause the user client device 100 to display the user interface further with a progress bar (or message) that indicates how close the user is to spending their predicted order budget (or weekly budget) on a given cart, which is updated as the user adds items to the cart.

The machine-learning training module 230 may collect information about the user's response to the list of recommended items (engagement information such as viewing information and/or conversion information). The machine-learning training module 230 may then use the collected information for updating the set of parameters of the revenue adjustment computer model, the set of parameters of the budget prediction computer model, and/or the set of parameters of the price sensitivity computer model.

In one or more embodiments, the machine-learning training module 230 collects training data that include information about success metrics for a defined time period (e.g., week, month, etc.) for a collection of users, such as: a number of items per order, a number of checkout conversions, a number of orders per user, GMV per item, some other suitable metric, or some combination thereof. The machine-learning training module 230 may perform, using the collected training data, initial training and re-training of the revenue adjustment computer model, the budget prediction computer model, and/or the price sensitivity computer model.

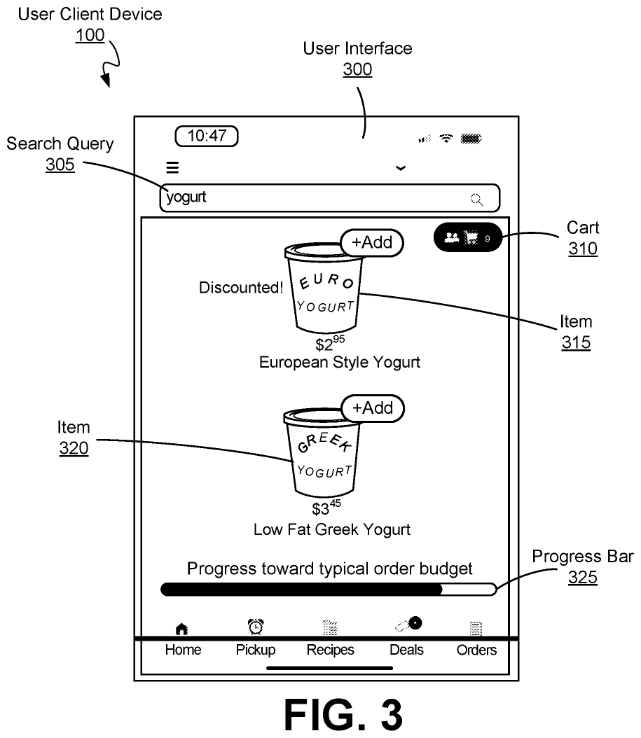

FIG. 3 illustrates an example user interface 300 of the user client device 100 with search results of a search query 305 entered by a user of the online concierge system 140, in accordance with one or more embodiments. The content presentation module 210 causes the user client device 100 to display the user interface 300 in response to the search query 305, e.g., “yogurt”. The user interface 300 may be displayed during an ordering session of the user (e.g., before the checkout) during which the user has already included a certain number of items into a cart 310. The content presentation module 210 causes the user interface 300 to display an item 315 (e.g., “European Style Yogurt”) and an item 320 (e.g., Low Fat Greek Yogurt). The items 315 and 320 are selected (e.g., by the search ranking module 260) as items with the highest final ranking scores, where a final ranking score of each item retrieved in response to the search query 305 is computed using a weight associated with a revenue objective that is adjusted (e.g., decreased) based on information about the user's session. As the item 315 is on discount, the item 315 is displayed at the top of the user interface 300. The item 315 may be displayed at the top of the user interface 300 also because there is a higher likelihood of the user converting the item 315 than the item 320, e.g., as determined by the item selection model. The information about the user's session used for adjusting the revenue objective weight may include information about a user's current progress toward a typical order budget for the user (e.g., estimated by the budget prediction module 270), which is displayed at the user interface 300 as a progress bar 325. Alternatively, the progress bar 325 may indicate a progress of the user's spend toward a typical average user's budget for a defined time period (e.g., weekly budget, monthly budget, etc.) The user may utilize the user interface 300 to add any of the recommended items 315, 320 into the cart 310.

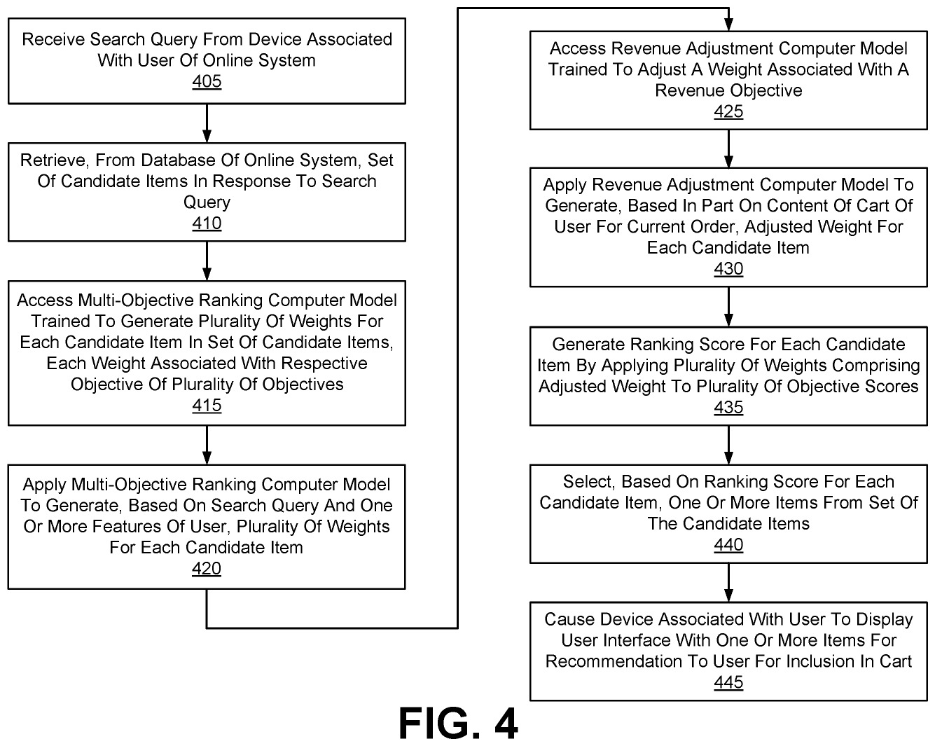

FIG. 4 is a flowchart for a method of using a trained computer model to adjust a weight of a revenue objective based on a session of a user of an online concierge system, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., the online concierge system 140). Additionally, each of these steps may be performed automatically by the online concierge system without human intervention.

The online concierge system 140 receives 405 (e.g., at the search query module 250) a search query from a device associated with a user of the online concierge system 140 (e.g., the user client device 100). The online concierge system 140 retrieves 410 (e.g., via the search query module 250), from a database of the online concierge system 140, (e.g., as available at the data store 240) a set of candidate items in response to the search query.

The online concierge system 140 accesses 415 a multi-objective ranking computer model of the online concierge system 140 (e.g., via the search ranking module 260) trained to generate a plurality of weights for each candidate item in the set of candidate items, each of the plurality of weights associated with a respective objective of a plurality of objectives. The online concierge system 140 applies 420 (e.g., via the search ranking module 260) the multi-objective ranking computer model to generate, based at least in part on the search query and one or more features of the user, the plurality of weights for each candidate item in the set of candidate items. The online concierge system 140 may apply the multi-objective ranking computer model (e.g., via the search ranking module 260) to generate, for each candidate item in the set of candidate items, the plurality of weights each associated with a respective one of a relevance objective, the revenue objective, an availability objective and a repeat purchasability objective of the plurality of objectives.

The online concierge system 140 accesses 425 a revenue adjustment computer model of the online concierge system 140 (e.g., via the revenue adjustment module 280) trained to adjust a weight of the plurality of weights that is associated with a revenue objective of the plurality of objectives. The online concierge system 140 applies 430 the revenue adjustment computer model (e.g., via the revenue adjustment module 280) to generate, based in part on content of a cart of the user for a current order, the adjusted weight for each candidate item in the set of candidate items. The online concierge system 140 generates 435 (e.g., via the search ranking module 260) a ranking score for each candidate item in the set of the candidate items by applying the plurality of weights comprising the adjusted weight to a plurality of objective scores, each of the plurality of objective scores associated with the respective objective of the plurality of objectives.

In one or more embodiments, the online concierge system 140 accesses a budget prediction computer model of the online concierge system 140 (e.g., via the budget prediction module 270) trained to predict a budget for the current order. The online concierge system 140 may apply the budget prediction computer model (e.g., via the budget prediction module 270) to estimate, based at least in part on an order history of the user for a defined time period, the budget for the current order. The online concierge system 140 may apply the revenue adjustment computer model (e.g., via the revenue adjustment module 280) to generate, further based on the estimated budget for the current order, the adjusted weight for each candidate item in the set of candidate items. In one or more embodiments, the online concierge system 140 applies the revenue adjustment computer model (e.g., via the revenue adjustment module 280) to generate, further based on at least one of a browsing activity of the user during the current order or a defined number of previous searches associated with the user, the adjusted weight associated with the revenue objective.

The online concierge system 140 may apply the revenue adjustment computer model (e.g., via the revenue adjustment module 280) to generate, based at least in part on a decay function of the weight, a total monetary value of the content of the cart and the estimated budget for the current order, the adjusted weight associated with the revenue objective. Alternatively, the online concierge system 140 may apply the revenue adjustment computer model (e.g., via the revenue adjustment module 280) to generate, based at least in part on a linear function of the weight, a total monetary value of the content of the cart and the estimated budget for the current order, the adjusted weight associated with the revenue objective.

In one or more embodiments, the online concierge system 140 generates (e.g., via the budget prediction module 270), based at least in part on an order history of the user (e.g., as available at the data store 240), an average budget for the user for a defined time period. The online concierge system 140 may estimate (e.g., via the budget prediction module 270), based at least in part on the average budget, a budget for the current order. The online concierge system 140 may apply the revenue adjustment computer model (e.g., via the revenue adjustment module 280) to generate, further based on the estimated budget for the current order, the adjusted weight for each candidate item in the set of candidate items.

In one or more embodiments, the online concierge system 140 generates (e.g., via the price sensitivity computation module 290), based on information about a current session of the user, a price sensitivity score for the current session of the user. The online concierge system 140 may apply the revenue adjustment computer model (e.g., via the revenue adjustment module 280) to generate, further based on the price sensitivity score, the adjusted weight for each candidate item in the set of candidate items.

The online concierge system 140 may collect (e.g., via the price sensitivity computation module 290) information about a monetary value for each item in a set of items the user interacted with during the current session. The online concierge system 140 may compute (e.g., via the price sensitivity computation module 290), for each item in the set of items, a ratio of the monetary value to an average price for a category of each item in the set of items. The online concierge system 140 may generate (e.g., via the price sensitivity computation module 290), based at least in part on the computed ratio for each item in the set of items, the price sensitivity score.

The online concierge system 140 may access a price sensitivity computer model of the online concierge system 140 (e.g., via the price sensitivity computation module 290) trained to generate the price sensitivity score for the current session of the user. The online concierge system 140 may apply the price sensitivity computer model (e.g., via the price sensitivity computation module 290) to generate, based on a first embedding associated with the current session and a second embedding associated with each item in a set of items the user interacted with during the current session, the price sensitivity score for the current session of the user.

The online concierge system 140 selects 440 (e.g., via the search ranking module 260), based on the ranking score for each candidate item, one or more items from the set of candidate items. The online concierge system 140 may compare (e.g., via the search ranking module 260) the ranking score for each candidate item with a threshold score and select (e.g., via the search ranking module 260) any item from the set candidate items having the corresponding ranking score exceeding the threshold score. Alternatively, the online concierge system 140 may select (e.g., via the search ranking module 260) a predetermined number of items from the set candidate items with highest ranking scores among all candidate items in the set of candidate items.

The online concierge system 140 causes 445 (e.g., via the content presentation module 210) the device associated with the user to display a user interface with the one or more items for recommendation to the user for inclusion in a cart. The online concierge system 140 may compute (e.g., via the budget prediction module 270), based at least in part on an order history of the user, an average budget for the user for a defined time period. The online concierge system 140 may cause the device associated with the user to display the user interface further with a difference between the average budget and a total monetary value of the content of the cart. The online concierge system 140 may collect (e.g., via the machine-learning computer module 230) feedback data with information about a conversion by the user of each of the one or more items. The online concierge system 140 may re-train (e.g., via the machine-learning computer module 230) the revenue adjustment computer model by updating, based at least in part on the collected feedback data, the set of parameters of the revenue adjustment computer model.

Embodiments of the present disclosure are directed to the online concierge system 140 that utilizes a trained revenue adjustment computer model to adjust weighting of a revenue objective based on a current session of a user of the online concierge system 140. The result of the multi-objective computer model is dynamically updated by applying the revenue adjustment computer model that adjusts the weight of the revenue objective based on information about the current session. The weight of the revenue objective may be adjusted based on how far a total monetary value of a user's cart is to a typical user's budget. Alternatively, the weight of the revenue objective may be adjusted based on a price sensitivity of the user during the current session.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving a search query from a device associated with a user of an online system;
retrieving, from a database of the online system, a set of candidate items in response to the search query;
accessing a multi-objective ranking computer model of the online system trained to generate a plurality of weights for each candidate item in the set of candidate items, each of the plurality of weights associated with a respective objective of a plurality of objectives;
applying the multi-objective ranking computer model to generate, based at least in part on the search query and one or more features of the user, the plurality of weights for each candidate item in the set of candidate items;
accessing a revenue adjustment computer model of the online system trained to adjust a weight of the plurality of weights that is associated with a revenue objective of the plurality of objectives;
applying the revenue adjustment computer model to generate, based in part on content of a cart of the user for a current order, the adjusted weight for each candidate item in the set of candidate items;
generating a ranking score for each candidate item in the set of the candidate items by applying the plurality of weights comprising the adjusted weight to a plurality of objective scores, each of the plurality of objective scores associated with the respective objective of the plurality of objectives;
selecting, based on the ranking score for each candidate item, one or more items from the set of the candidate items; and
causing the device associated with the user to display a user interface with the one or more items for recommendation to the user for inclusion in a cart.

2. The method of claim 1, further comprising:
accessing a budget prediction computer model of the online system trained to predict a budget for the current order; and
applying the budget prediction computer model to estimate, based at least in part on an order history of the user for a defined time period, the budget for the current order,
wherein applying the revenue adjustment computer model comprises applying the revenue adjustment computer model to generate, further based on the estimated budget for the current order, the adjusted weight for each candidate item in the set of candidate items.

3. The method of claim 2, wherein applying the revenue adjustment computer model further comprises:
applying the revenue adjustment computer model to generate, based at least in part on a decay function of the weight, a total monetary value of the content of the cart and the estimated budget for the current order, the adjusted weight associated with the revenue objective.

4. The method of claim 2, wherein applying the revenue adjustment computer model further comprises:
applying the revenue adjustment computer model to generate, based at least in part on a linear function of the weight, a total monetary value of the content of the cart and the estimated budget for the current order, the adjusted weight associated with the revenue objective.

5. The method of claim 1, further comprising:
generating, based at least in part on an order history of the user, an average budget for the user for a defined time period; and
estimating, based at least in part on the average budget, a budget for the current order,
wherein applying the revenue adjustment computer model comprises applying the revenue adjustment computer model to generate, further based on the estimated budget for the current order, the adjusted weight for each candidate item in the set of candidate items.

6. The method of claim 1, wherein applying the revenue adjustment computer model comprises:
applying the revenue adjustment computer model to generate, further based on at least one of a browsing activity of the user during the current order or a defined number of previous searches associated with the user, the adjusted weight associated with the revenue objective.

7. The method of claim 1, wherein applying the multi-objective ranking computer model comprises:
applying the multi-objective ranking computer model to generate, for each candidate item in the set of candidate items, the plurality of weights each associated with a respective one of a relevance objective, the revenue objective, an availability objective and a repeat purchasability objective of the plurality of objectives.

8. The method of claim 1, further comprising:
generating, based on information about a current session of the user, a price sensitivity score for the current session of the user,
wherein applying the revenue adjustment computer model comprises applying the revenue adjustment computer model to generate, further based on the price sensitivity score, the adjusted weight for each candidate item in the set of candidate items.

9. The method of claim 8, wherein generating the price sensitivity score comprises:
collecting information about a monetary value for each item in a set of items the user interacted with during the current session;
computing, for each item in the set of items, a ratio of the monetary value to an average price for a category of each item in the set of items; and
generating, based at least in part on the computed ratio for each item in the set of items, the price sensitivity score.

10. The method of claim 8, wherein generating the price sensitivity score comprises:
accessing a price sensitivity computer model of the online system trained to generate the price sensitivity score for the current session of the user; and
applying the price sensitivity computer model to generate, based on a first embedding associated with the current session and a second embedding associated with each item in a set of items the user interacted with during the current session, the price sensitivity score for the current session of the user.

11. The method of claim 1, further comprising:
collecting feedback data with information about a conversion by the user of each of the one or more items; and
re-training the revenue adjustment computer model by updating, based at least in part on the collected feedback data, a set of parameters of the revenue adjustment computer model.

12. The method of claim 1, wherein displaying the user interface comprises:
computing, based at least in part on an order history of the user, an average budget for the user for a defined time period; and
causing the device associated with the user to display the user interface further with a difference between the average budget and a total monetary value of the content of the cart.

13. A computer program product comprising a non-transitory computer readable storage medium having instructions encoded thereon that, when executed by a processor, cause the processor to perform steps comprising:
receiving a search query from a device associated with a user of an online system;
retrieving, from a database of the online system, a set of candidate items in response to the search query;
accessing a multi-objective ranking computer model of the online system trained to generate a plurality of weights for each candidate item in the set of candidate items, each of the plurality of weights associated with a respective objective of a plurality of objectives;
applying the multi-objective ranking computer model to generate, based at least in part on the search query and one or more features of the user, the plurality of weights for each candidate item in the set of candidate items;
accessing a revenue adjustment computer model of the online system trained to adjust a weight of the plurality of weights that is associated with a revenue objective of the plurality of objectives;
applying the revenue adjustment computer model to generate, based in part on content of a cart of the user for a current order, the adjusted weight for each candidate item in the set of candidate items;
generating a ranking score for each candidate item in the set of the candidate items by applying the plurality of weights comprising the adjusted weight to a plurality of objective scores, each of the plurality of objective scores associated with the respective objective of the plurality of objectives;
selecting, based on the ranking score for each candidate item, one or more items from the set of the candidate items; and
causing the device associated with the user to display a user interface with the one or more items for recommendation to the user for inclusion in a cart.

14. The computer program product of claim 13, wherein the instructions further cause the processor to perform steps comprising:
accessing a budget prediction computer model of the online system trained to predict a budget for the current order;
applying the budget prediction computer model to estimate, based at least in part on an order history of the user for a defined time period, the budget for the current order; and
applying the revenue adjustment computer model to generate, further based on the estimated budget for the current order, the adjusted weight for each candidate item in the set of candidate items.

15. The computer program product of claim 14, wherein the instructions further cause the processor to perform steps comprising:
applying the revenue adjustment computer model to generate, based at least in part on a defined function of the weight, a total monetary value of the content of the cart and the estimated budget for the current order, the adjusted weight associated with the revenue objective.

16. The computer program product of claim 13, wherein the instructions further cause the processor to perform steps comprising:
applying the revenue adjustment computer model to generate, further based on at least one of a browsing activity of the user during the current order or a defined number of previous searches associated with the user, the adjusted weight associated with the revenue objective.

17. The computer program product of claim 13, wherein the instructions further cause the processor to perform steps comprising:
generating, based on information about a current session of the user, a price sensitivity score for the current session of the user; and
applying the revenue adjustment computer model to generate, further based on the price sensitivity score, the adjusted weight for each candidate item in the set of candidate items.

18. The computer program product of claim 17, wherein the instructions further cause the processor to perform steps comprising:
collecting information about a monetary value for each item in a set of items the user interacted with during the current session;
computing, for each item in the set of items, a ratio of the monetary value to an average price for a category of each item in the set of items; and
generating, based at least in part on the computed ratio for each item in the set of items, the price sensitivity score.

19. The computer program product of claim 17, wherein the instructions further cause the processor to perform steps comprising:
accessing a price sensitivity computer model of the online system trained to generate the price sensitivity score for the current session of the user; and
applying the price sensitivity computer model to generate, based on a first embedding associated with the current session and a second embedding associated with each item in a set of items the user interacted with during the current session, the price sensitivity score for the current session of the user.

20. A computer system comprising:
a processor; and
a non-transitory computer-readable storage medium having instructions that, when executed by the processor, cause the computer system to perform steps comprising:
receiving a search query from a device associated with a user of an online system;
retrieving, from a database of the online system, a set of candidate items in response to the search query;
accessing a multi-objective ranking computer model of the online system trained to generate a plurality of weights for each candidate item in the set of candidate items, each of the plurality of weights associated with a respective objective of a plurality of objectives;
applying the multi-objective ranking computer model to generate, based at least in part on the search query and one or more features of the user, the plurality of weights for each candidate item in the set of candidate items;
accessing a revenue adjustment computer model of the online system trained to adjust a weight of the plurality of weights that is associated with a revenue objective of the plurality of objectives;
applying the revenue adjustment computer model to generate, based in part on content of a cart of the user for a current order, the adjusted weight for each candidate item in the set of candidate items;
generating a ranking score for each candidate item in the set of the candidate items by applying the plurality of weights comprising the adjusted weight to a plurality of objective scores, each of the plurality of objective scores associated with the respective objective of the plurality of objectives;
selecting, based on the ranking score for each candidate item, one or more items from the set of the candidate items; and
causing the device associated with the user to display a user interface with the one or more items for recommendation to the user for inclusion in a cart.
